(19) United States
(12) Patent Application Publication
(10) Pub. No.: US 2008/0105643 A1
(43) Pub. Date: May 8, 2008

(54) FASTENER DEVICE AND A DISPENSER USING SUCH A DEVICE

(75) Inventors: Alex MILIAN, Les Baux De Breteuil (FR); Beatrice Boileau, Vitot (FR)

Correspondence Address: SUGHRUE MION, PLLC, 2100 PENNSYLVANIA AVENUE, N.W., SUITE 800, WASHINGTON, DC, 20037, US

(73) Assignee: VALOIS SAS, LE NEUBOURG (FR)

(21) Appl. No.: 11/936,450

(22) Filed: Nov. 7, 2007

Related U.S. Application Data
(60) Provisional application No. 60/899,002, filed on Feb. 2, 2007.

(30) Foreign Application Priority Data
Nov. 7, 2006 (FR) 06.54763

(51) Int. Cl. B05B 11/00; B65D 45/32

(52) U.S. Cl. 215/272; 222/321.1

(57) ABSTRACT

A fastener device (4, 5) for fastening a fluid dispenser member (2), such as a pump or a valve, on a neck (11) of a fluid reservoir (1), said device comprising:
a fastener ring (4) including both a reception housing (47) that is suitable for receiving, in stationary manner, the dispenser member (2), and fastener means (42) for holding the ring (4) on the reservoir (1), the fastener means (42) being formed at a bushing (41) that can be locally deformed radially outwards while the ring is being mounted on the reservoir; and
a covering ferrule (5) that surrounds, at least in part, the bushing (41) of the fastener ring (4), the ferrule being at a distance from the bushing (41) at the fastener means (42), so as to form a free intermediate gap (E) making it possible to deform the bushing (41) radially outwards;
the device being characterized in that the ferrule (5) is engaged with a wall (412) of the ring (4) that is directed radially inwards.

### CROSS REFERENCE TO RELATED APPLICATION

This application claims the benefit under 35 U.S.C. §119(e) of pending U.S. provisional patent application Ser. No. 60/899,002, filed Feb. 2, 2007, and priority under 35 U.S.C. §119(a)-(d) of French patent application No. FR-06.54763, filed Nov. 7, 2006.

### TECHNICAL FIELD

The present invention relates to a fastener device for fastening a fluid dispenser member, such as a pump or a valve, on a neck of a fluid reservoir. The fastener device comprises a fastener ring and an outer covering ferrule. The ring includes both a reception housing that is suitable for receiving, in stationary manner, the pump or the valve, and fastener means for holding the ring on the reservoir. The present invention applies more particularly to the fields of perfumery, cosmetics, or pharmacy, in which it is common to use manual pumps and valves that can be actuated by means of a finger so as to dispense doses of fluid optionally in spray form.

### BACKGROUND OF THE INVENTION

In the prior art, there already exist numerous fastener devices using a fastener ring and a covering ferrule that comes to cover the fastener ring. In general, the fastener ring is made of a molded plastics material, whereas the covering ferrule is made of metal for reasons of appearance. The ring that incorporates the fastener means must be capable of being subjected to elastic deformation, so as to enable it to be mounted on the neck of the receptacle. The elastic deformation is performed radially outwards, such that the diameter of the ring at the fastener means is increased temporarily. A typical reservoir neck includes a thickened outer edge that forms a downwardly-directed bottom shoulder. It is the shoulder that serves as a fastener zone for the fastener means of the ring. In a well-known embodiment of the prior art, the fastener means can be in the form of a continuous bead or in the form of a plurality of discontinuous lugs that project radially inwards. In order to reach their permanent fastened position below the shoulder of the neck, the fastener means must pass over the thickened edge. Naturally, this causes the ring to deform radially outwards at the snap-fastener means.

Such a fastener ring serves alone to hold the dispenser member in stable manner on the neck of the reservoir. The covering ferrule is not involved in, nor does it participate in, fastening the ring on the neck. The covering ferrule thus fulfills only an appearance function. The fastener means of the ring can also qualify as snap-fastener means, since they are in the form of outwardly-projecting profiles for coming to be housed in a housing defined by the bottom shoulder of the neck.

In general, such a fastener device is assembled in two steps. During the first step, the fastener ring is mounted on the neck of the reservoir. During a second step, the covering ferrule is mounted on the fastener ring. Document WO 99/20401 describes another way of assembling such a fastener device. In that document, the fastener ring described forms outer recesses at the fastener means. Thus, a free intermediate gap is defined between the outer wall of the ring at the fastener means and the inner wall of the covering ferrule. The free intermediate gap provides clearance for the fastener ring while it is being deformed radially outwards. The recesses formed in the outer wall of the ring do not extend over the entire height of the ring, but only over its bottom portion. In addition, the ferrule is in contact with the ring between each recess. In that prior-art fastener device, the ferrule is held on the ring exclusively by radial clamping. The inner wall of the ferrule is in clamping contact with the outer wall of the ring. The shape of the ferrule is therefore imposed by the shape of the ring. In addition, that design requires manufacturing tolerances to be very small, since the ferrule must be capable of being mounted on the ring with sufficient radial clamping to guarantee that the ferrule is prevented from turning and from moving in axial translation on the ring. Clamping that is too tight causes the ferrule to be locally deformed.

### BRIEF SUMMARY OF THE INVENTION

An object of the present invention is remedy the above-mentioned drawbacks of the prior art by defining another fastener device that makes it possible to pre-assemble the ferrule on the ring in effective and permanent manner, while guaranteeing significant freedom for the shape of the ferrule.

To achieve this object, the present invention proposes a fastener device for fastening a fluid dispenser member, such as a pump or a valve, on an opening of a fluid reservoir, said device comprising: a fastener ring including both a reception housing that is suitable for receiving, in stationary manner, the dispenser member, and fastener means for holding the ring on the reservoir, the fastener means being formed at a bushing that can be locally deformed radially outwards while the ring is being mounted on the reservoir; and a covering ferrule that surrounds, at least in part, the bushing of the fastener ring, the ferrule being at a distance from the bushing at the fastener means, so as to form a free intermediate gap making it possible to deform the bushing radially outwards; the device being characterized in that the ferrule is engaged with a wall of the ring that is directed radially inwards. Thus, the ferrule does not need to surround the ring, clamping it radially from the outside, thereby making it possible to make the ferrule of shapes that are independent from the shape of the ring. The bushing advantageously includes an inner wall and an outer wall, the fastener means are formed on the inner wall, the intermediate gap being formed between the outer wall of the bushing and the ferrule, the ferrule being engaged with the inner wall of the bushing. In an embodiment, the inner wall is formed with a plurality of holding profiles for coming into engagement with the ferrule. The ferrule thus comes into clamping contact at the holding profiles that can be distributed angularly in regular manner. The holding profiles can be deformed by the ferrule. The ferrule can even be deformed a little by the holding profiles, but without affecting the appearance of the ferrule, since the ferrule is not visible at the location where it comes into engagement with the inner wall of the bushing. Instead of holding profiles, it is also possible to provide for the ferrule to come into continuous annular contact with the inner wall of the bushing or of the ring.

In a practical embodiment, the ring includes an annular radial plate that connects the bushing to the reception housing, the bushing thus defining a top bushing section extending above the plate, and a bottom bushing section extending below the plate, the fastener means being formed on the bottom section, and the holding profiles being formed on the top section.

In another advantageous aspect of the invention, the ferrule includes a top end and a bottom end, the top end forming a lip extending axially downwards from the inner periphery of the rim. The top end of the ferrule preferably includes an annular rim that extends substantially radially inwards, the lip extending axially downwards from the inner periphery of the rim. Thus, the lip of the ferrule penetrates inside the ring and is thus no longer visible. The lip is in the form of an inwardly-directed cuff or turn-up. The lip can extend coaxially inside the body of the ferrule. The lip can present a cylindrical configuration. The annular rim of the ferrule can come to bear against the top end of the bushing. Fastening the lip to the inside of the ring can be achieved using numerous fastening techniques. It is possible to provide simple clamping, or even snap-fastening, catching barbs, or anchoring by an interference fit.

In another advantageous aspect of the invention, the ferrule is also engaged with the ring at its bottom end. The bottom end of the ferrule advantageously includes catch means that are suitable for coming into engagement under an edge of the ring. The catch means can be in the form of snap-fastener means comprising a snap-fastener profile for becoming housed under the bottom end of the ring. Thus, the ferrule is prevented from moving in axial translation at both of its ends. In addition, the ferrule is prevented from moving radially by the lip that comes into engagement inside the ring. As a result, it is possible that the ferrule is out of contact with the ring over its entire height, except at both of its ends. The free intermediate gap can thus extend axially in continuous manner between the lip and the catch means of the ferrule.

In another aspect of the invention, the bushing of the ring forms an outwardly-directed shoulder below the fastener means. The shoulder makes it possible to offset the bottom end of the ring outwards so as to make it easier to create the free intermediate gap, making it momentarily possible to expand the ring locally while it is being mounted on the neck of a reservoir.

Whereas the prior art provides radial clamping on the outside of the ring, the present invention provides fastening the ferrule inside the ring using an inwardly-directed lip that is advantageously provided at the top end of the ferrule. Thus, the outer wall of the ring can be completely free of contact with the ferrule.

The present invention also defines a fluid dispenser comprising: a fluid reservoir provided with a neck; a dispenser member such as a pump or a valve; and a fastener device as defined above for fastening the dispenser member on the neck of the reservoir.

### BRIEF DESCRIPTION OF THE DRAWINGS

The invention is described more fully below with reference to the accompanying drawings which show three embodiments of the invention by way of non-limiting example.

In the figures:

FIG. 1 is a vertical-section view through a fluid dispenser constituting a first embodiment of the invention;

FIGS. 2a, 2b, and 3 are perspective views of the fastener ring of the invention;

FIGS. 4a and 4b are vertical-section views through the ring of FIGS. 2a, 2b, and 3; and

FIGS. 5 and 6 are vertical-section views through fastener devices constituting two other embodiments of the invention.

### DETAILED DESCRIPTION

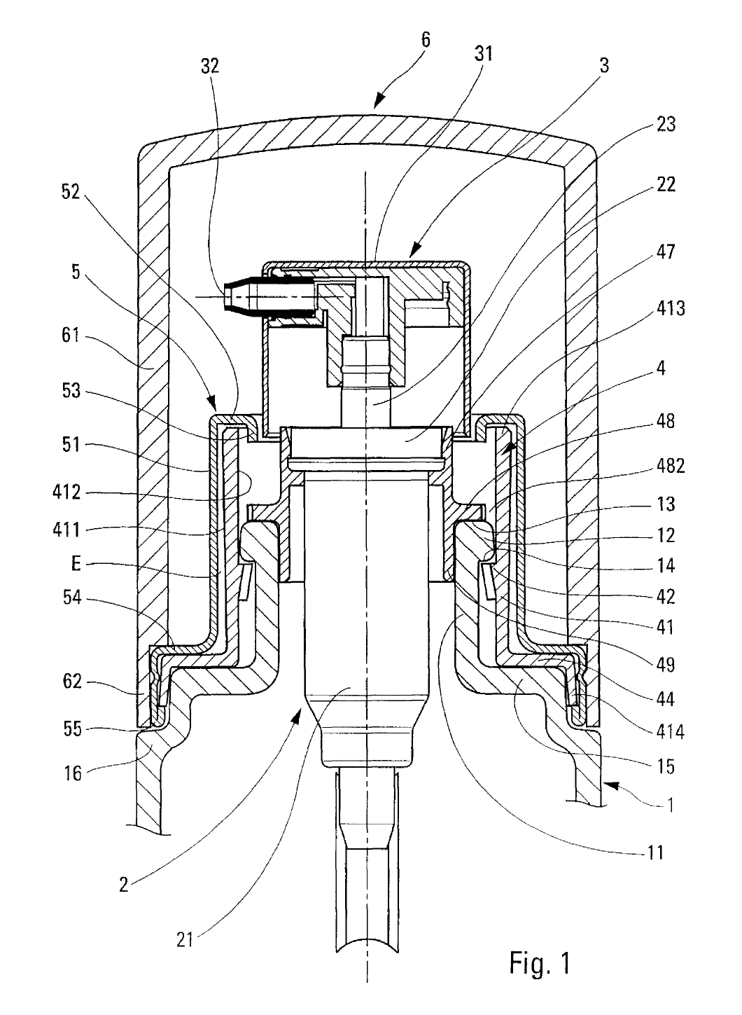

Reference is made firstly to FIGS. 1 to 4b in order to describe in detail a first embodiment of the invention. The fastener device of the present invention comprises two component elements, namely a fastener ring 4 and an outer covering ferrule 5. The fastener ring 4 can advantageously be made of plastics material by means of an injection-molding method. As for the ferrule, it too can be made of plastics material, but it is preferably made of metal. The ferrule 5 has the function of covering the fastener ring at least in part, and preferably completely. The fastener ring 4 is thus completely masked by the ferrule. The ferrule presents a pleasing finished appearance: that is why it is often made of metal. The ring 4 and the ferrule 5 are thus made separately, then assembled together in such a manner as to constitute a single unit. The ferrule can be assembled on the ring before the ring is mounted on a receptacle neck. However, there is nothing to prevent the ferrule from being mounted on the ring after said ring has been mounted on a receptacle neck. In the present embodiment, the function of the ferrule 5 is purely esthetic, and does not contribute to fastening the ring on the receptacle neck.

In FIG. 1, the fastener device of the invention is shown in association with a receptacle 1, a dispenser member 2, a pusher 3, and a protective cap 6.

The reservoir 1 can be made of any material, such as glass or a plastics material, for example. The top portion only of the reservoir 1 is shown in FIG. 1. In this embodiment, the reservoir includes a neck 11 that projects from a shoulder 15 that is above a rim 16. The neck 11 is made in conventional manner with a thickened reinforcement or edge 12 that projects radially outwards in such a manner as to define a bottom shoulder 14 that is directed downwards. At its top end, the neck 11 defines an annular edge 13. The function of the bottom shoulder 14 is to serve as a fastener surface for the fastener ring 4. The ring is clamped on the neck between the shoulder 14 and the top edge 13. The neck 11 can also be defined as forming a fastener or snap-fastener housing defined below the shoulder 14.

The dispenser member 2 can be a pump or a valve. In the present embodiment, the dispenser member is a pump. The pump includes a body 21 defining, at its top end, a fastener collar 22. The pump also includes an actuator rod 23 that projects axially upwards out from the body 21. The actuator rod 23 is axially displaceable down and up inside the body 21. The free end of the actuator rod 23 is covered by a pusher 3 that defines a bearing surface 31 on which the user can press by means of one or more fingers, so as to displace the pusher and the actuator rod. The pusher also defines a dispenser orifice 32 that can be a spray nozzle. The internal structure of the dispenser member is not described below, since it is not critical to the present invention.

The function of the fastener device, formed by the ring 4 and the ferrule 5, is to hold the dispenser member in stationary and leaktight manner on the reservoir 1. In this embodiment, the leaktight fastening is provided only by the ring 4. To do this, the ring 4 includes a reception housing 47 in which the projecting collar 22 of the body 21 of the dispenser member 2 is received. By way of example, the projecting collar 22 can be held by being snap-fastened in the reception housing 47. It is also possible to envisage other fastening techniques, such as catching barbs or crimping. Naturally, the housing 47 is formed with a central through hole, so as to enable the body 21 to extend through the housing 47. In the embodiment shown in FIG. 1, the ring 4 also includes a self-sealing sleeve 49, which, in this embodiment, extends downwards in line with the housing 47. The function of the sleeve 49 is to be inserted inside the neck 11 of the reservoir so as to make said neck leaktight. In addition, the ring 4 includes an annular plate 48 that extends radially outwards from the housing 47 and from the sleeve 49. In this embodiment, the plate 48 can be considered as extending between the housing 47 and the sleeve 49. The function of the plate 48 is to rest on the top edge 13 of the neck 11. The plate 48 is pierced with a plurality of through windows 482 having a function that is explained below. The ring 4 also includes an outer bushing 41 that is connected to the outer periphery of the plate 48. The bushing 41 includes an outer wall 411 and an inner wall 412. The plate 48 is connected to the bushing 41 at its inner wall 412. The wall 412 extends radially inwards, facing the reception housing 47 and the seal-sealing sleeve 49. A top gap is thus formed between the inner wall 412, the plate 48, and the housing 47. Another gap, a bottom gap, is formed between the wall 412, the plate 48, and the sleeve 49. The bottom gap is also defined or closed in part by fastener means 42 that are formed on the inner wall 412 of the bushing 41. The fastener means 42 are in the form of profiles that project radially inwards. In the embodiment shown, there are four fastener profiles. They are separate from one another and are distributed at equal angles over the inner periphery of the wall 412. Instead of the discontinuous profiles, it is also possible to provide a continuous annular bead that projects over the inner wall 412 of the bushing. In this embodiment, the fastener profiles 42 are configured with a shallow slope and a sharp edge, so as to make it easier to insert the projecting annular reinforcement 12 of the fastener neck, and so as to enable said reinforcement to be held firmly and permanently in place. As shown in FIG. 1, the neck comes into contact with the ring at various points. Initially, the top edge 13 of the neck comes into abutment against the plate 48. The inner wall of the neck comes into contact with the self-sealing sleeve 49. In addition, the inner wall 412 of the bushing 41 comes into contact with the annular reinforcement 12. In addition, the bottom shoulder 14 comes into bearing contact against the fastener profiles 42 of the bushing 41. In this way, the neck is held in completely stable and permanent manner in the ring 4. It will readily be understood that the bushing 41 must deform radially outwards, so as to enable the fastener profiles 42 to reach their final position below the shoulder 14 of the neck. It is necessary for the profiles 42 to pass over the annular reinforcement 12 of the neck that presents a diameter that is naturally greater than the diameter of the shoulder 14. In other words, the outside diameter of the bushing increases momentarily while the fastener means are passing over the annular reinforcement 12. Once the reinforcement 12 has been passed over, the bushing returns to its normal configuration, as shown in FIG. 1. A very small amount of deformation can remain: said deformation makes it possible to guarantee that the neck is completely stable inside the ring.

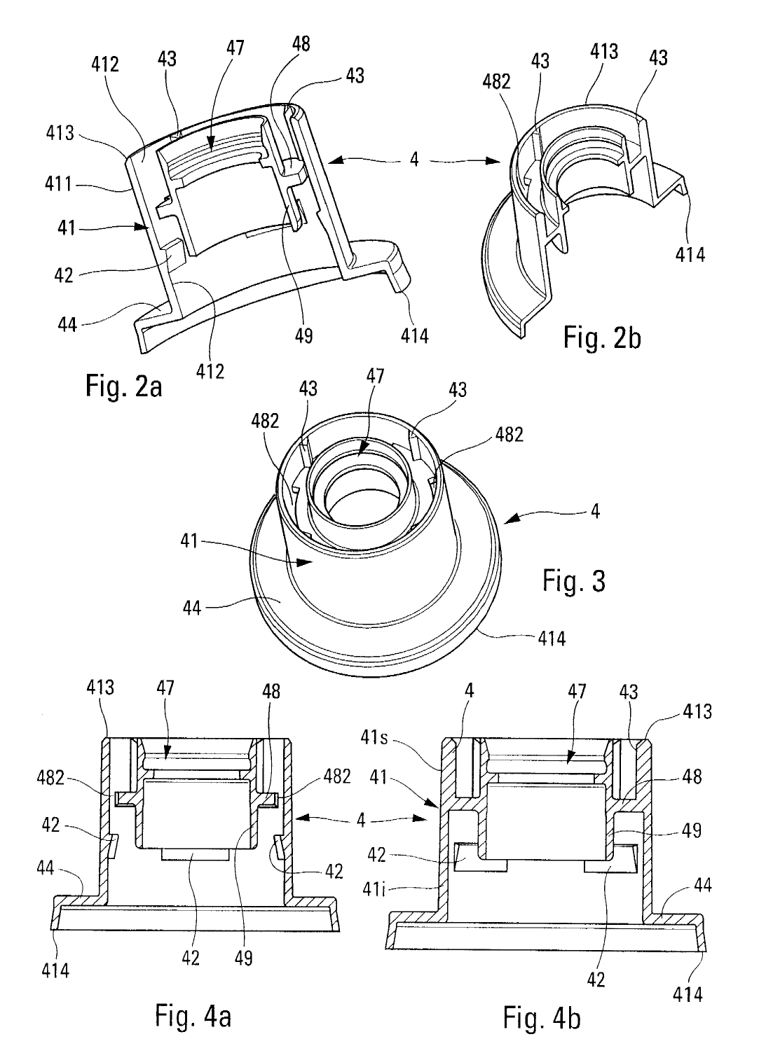

The ring 4, which is shown in detail in FIGS. 2a, 2b, 3, 4a, and 4b, also defines a top end 413 and a bottom end 414. Between these two ends, the bushing includes a first cylindrical segment on which there are formed the fastener means 42 and the junction between the plate and the bushing. The reception housing 47 and the self-sealing sleeve 49 are disposed in coaxial manner inside the cylindrical portion. At its bottom end, the cylindrical portion is extended radially outwards by an annular shoulder 44. The shoulder 44 then extends downwards, so as to form the bottom end 414 of the bushing. The shoulder 44 thus forms an outwardly-directed step. The bushing 41 thus presents a stepped configuration.

In an embodiment of the invention, the inner wall 412 of the bushing is also formed with holding profiles 43 that project radially inwards from the wall 412. The holding profiles 43 are formed at the top portion of the bushing situated above the plate 48. In this embodiment, the holding profiles 43 are in the form of vertical longitudinal splines that extend from the top end 413 of the bushing up to the plate 48. Instead of vertical splines 43, it is also possible to provide more complex profiles forming holding housings for holding by snap-fastening or catching, for example. It is also possible to provide for the wall 412 to be bare of any holding profile. In this event, it is possible to provide for the wall thickness of the bushing at this point to be thickened over its entire periphery, for example. It should be observed in FIGS. 2a to 4b that the splines 43 are angularly offset relative to the windows 482. It should also be observed that the windows 482 are situated vertically in register with the fastener means 42. The function of the windows 482 is to make it possible to mold the top portion of the fastener means 42 by passing a core through the window 482.

It should also be considered that the bushing 41 includes a top bushing section 41s situated above the plate 48, and a bottom bushing section 41i extending below the plate 48. In this embodiment, it can be said that the fastener means 42 are situated in the bottom bushing section 41i, whereas the holding profiles 43 are situated in the top bushing section 41s. The shoulder 44 is also formed in the bottom bushing section 41i.

The ferrule 5 includes a cylindrical main segment 51, an inwardly-directed top rim 52, an inner lip 53, and an outer shoulder 54. The main segment 51 surrounds the main segment of the bushing 41. The inwardly-directed rim 52 extends over the top end 413 of the bushing. The inner lip 53 extends inside the bushing and comes into fastening engagement with the inner wall 412. More precisely, the lip 53 comes into engagement with the splines 43. In this way, the ferrule 5 is fastened to the ring 4. Fastening can be achieved by simple clamping, or even by snap-fastening, by catching barbs, or by an interference fit. By way of example, it is possible to provide for the lip 53 to form one or more snap-fastener or barb heads for coming into engagement in corresponding housings formed in the inner wall 412 of the bushing. In the figures, the inner wall 412 is formed with holding profiles 43. However, it is possible to envisage a wide range of embodiments for fastening the lip 53 inside the bushing 41. It is even possible to provide for the lip 53 to be formed with teeth that come to bite into the inner wall 412, or even into the plate 48. The fastening principle of the invention resides in the providing the fastening not on the outside of the bushing, but on the inside of the bushing. It is thus no longer necessary to perform clamping on the outer wall 411 of the bushing. The main segment 51 of the ferrule can thus be at a distance from the outer wall 411 of the bushing, in such a manner as to form a free annular intermediate gap E. The gap E provides clearance for the deformation of the bushing 41 while the fastener means 42 are passing over the thickened reinforcement 12 of the neck 11. It can be seen in FIG. 1 that the gap E extends over the entire height of the main segment 51 of the ferrule. The inwardly-directed rim 42 is not even forced to come into contact with the top end 413 of the bushing 41. It should be observed that the shoulder 54 comes into contact against the shoulder 44 of the bushing.

It should also be observed that the bottom end of the ferrule is made with catch means 55 that fasten under the edge of the ring, which edge, in this embodiment, is formed by the bottom end 414 of the ring. The catch means 55 comprise a profile that projects radially inwards. In this embodiment, the profile is made by turning up the bottom portion of the ferrule inwardly. It is also possible to make other forms of catch means, as described below.

Thus, the ferrule 5 is mounted in completely stable and permanent manner on the ring 4 without performing radial clamping on the outer wall of the bushing 41. Engaging the lip 53 in the bushing 41 guarantees radial stability for the ferrule, and can also contribute to preventing it from turning. With regard to catching the ferrule on the bottom portion of the ring, this guarantees axial stability. It should be observed that the ferrule 5 comes into contact with the ring only at the lip 53, the shoulder 54, and the catch means 55.

In the final assembled position, as shown in FIG. 1, the shoulder 44 of the ring comes to rest on the shoulder 15 of the neck. In addition, it should be observed that the bottom part of the ferrule comes to be housed above the rim 16 of the neck. The protective cap 6 advantageously covers the entire unit by becoming engaged with its bottom edge 62 in an annular groove formed by the ferrule. The cap 6 is thus held on the ferrule by a weak snap-fastening. The cap 6 can advantageously extend upwards in line with the reservoir body.

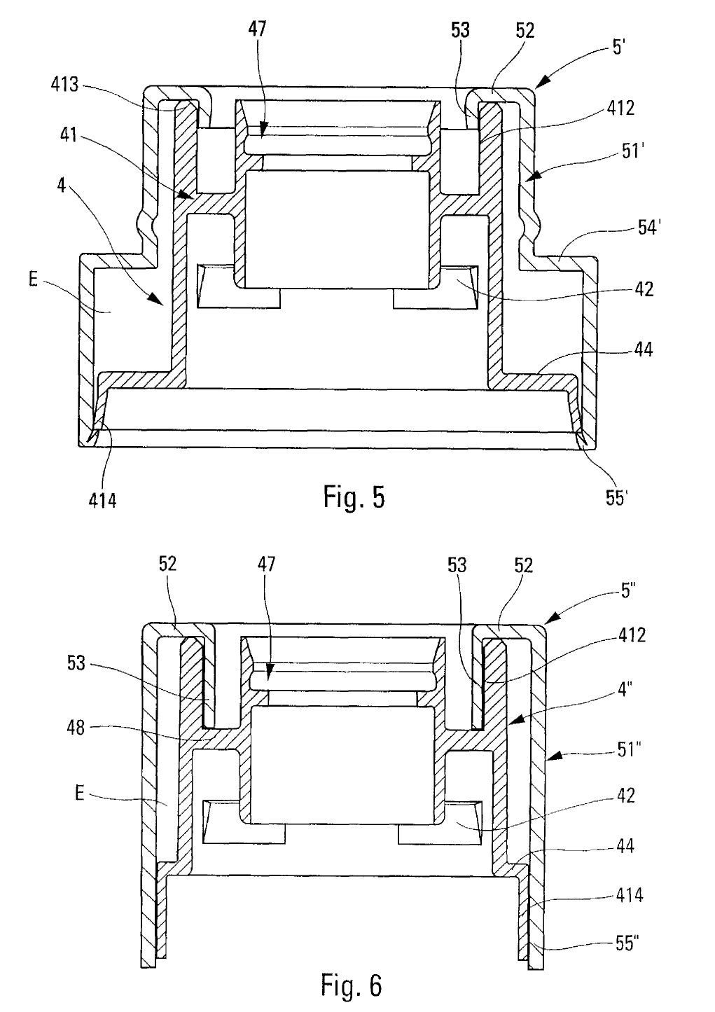

Reference is made below to FIGS. 5 and 6 which show two other embodiments of the invention for the fastener device. In FIG. 5, the ring 4 can be identical to the ring of the first embodiment. With regard to the ferrule 5′, it differs from the ferrule 5 of the first embodiment in that the shoulder 54′ is spaced apart from the shoulder 44. In addition, the catch means 55′ are not made by being turned up, but by pushing material inwards in such a manner as to form a barb of material that projects inwards and upwards, and that is for coming into engagement under an edge of the ring, e.g. constituted by its bottom end. It should be observed that the free intermediate gap E is greater than in the first embodiment, thereby making it possible to use fastener means in which the bushing deforms to a greater extent in order to pass over the neck. The lip 53 can be fastened inside the bushing by means of holding profiles 43 such as the holding profiles of the first embodiment, or by any other means such as snap-fastening, catching barbs, or an interference fit. It is even possible quite simply to provide for the inner wall 412 not to have any profiles, and thus to constitute a perfectly cylindrical surface on which the lip is fastened by inner radial clamping.

In the embodiment in FIG. 6, the ring 4″ is somewhat different from the ring of the first two embodiments in that the shoulder 44 is shorter, and in that its bottom end 414 is perfectly cylindrical. The ferrule 5′ is also different from the first two embodiments in that the lip 53 is longer and extends into contact with the plate 48. At its bottom end, the catch means 55′ of the ferrule for catching on the bottom end 414 of the ring are provided merely by radial clamping. However, it should be observed that the free gap E extends from the shoulder 44 up to the rim 52. In this embodiment, outer radial clamping is used on the outer wall on the bushing. However, the radial clamping is limited to the bottom portion of the bushing that is situated below the fastener means 42, such that they can be displaced freely outwards by means of the bushing deforming into the gap E.

In all of the embodiments, the ferrule comes into engagement with an inner wall of the ring that is oriented radially inwards, i.e. towards the axis of symmetry of the ring. In this embodiment, the inner wall is formed by the bushing 41, but it is also possible to provide for the inner wall to be formed by another element or portion of the ring. Fastening the ferrule on the ring at an inner wall of said ring is particularly advantageous, since it is not necessary to worry about the ferrule possibly deforming at the point at which it comes into engagement with the inner wall of the ring, given that said portion of the ferrule is not visible to the user. This internal and non-visible engagement makes it possible for the ferrule to be spaced apart from the outer wall of the ring, in such a manner as to create a sufficient or oversized gap E that provides clearance for the fastener means 42.

1. A fastener device (4; 4″, 5; 5′; 5″) for fastening a fluid dispenser member (2), such as a pump or a valve, on a neck (11) of a fluid reservoir (1), said device comprising:
a fastener ring (4; 4″) including both a reception housing (47) that is suitable for receiving, in stationary manner, the dispenser member (2), and fastener means (42) for holding the ring on the reservoir (1), the fastener means (42) being formed at a bushing (41) that can be locally deformed radially outwards while the ring is being mounted on the reservoir; and
a covering ferrule (5; 5′; 5″) that surrounds, at least in part, the bushing (41) of the fastener ring (4; 4″), the ferrule being at a distance from the bushing (41) at the fastener means (42), so as to form a free intermediate gap (E) making it possible to deform the bushing (41) radially outwards;
the device being characterized in that the ferrule (5; 5′; 5″) is engaged with a wall (412) of the ring that is directed radially inwards.

2. A fastener device according to claim 1, in which the bushing (41) includes an inner wall (412) and an outer wall (411), the fastener means (42) are formed on the inner wall (412), the intermediate gap (E) being formed between the outer wall (411) of the bushing and the ferrule (5; 5′; 5″), the ferrule being engaged with the inner wall (412) of the bushing (41).

3. A fastener device according to claim 1, in which the inner wall (412) is formed with a plurality of holding profiles (43) for coming into engagement with the ferrule.

4. A fastener device according to claim 3, in which the ring (4; 4″) includes an annular radial plate (48) that connects the bushing (41) to the reception housing (47), the bushing (41) thus defining a top bushing section (41s) extending above the plate (48), and a bottom bushing section (41i) extending below the plate (48), the fastener means (42) being formed on the bottom section (41i), and the holding profiles (43) being formed on the top section (41s).

5. A fastener device according to claim 1, in which the ferrule includes a top end and a bottom end, the top end forming an inner rim (53) that is engaged with the inner wall (412) of the ring.

6. A fastener device according to claim 5, in which the top end of the ferrule includes an annular rim (52) that extends substantially radially inwards, the lip (53) extending axially downwards from the inner periphery of the rim (52).

7. A fastener device according to claim 5, in which the ferrule (5; 5′; 5″) is also engaged with the ring (4; 4″) at its bottom end.

8. A fastener device according to claim 7, in which the bottom end of the ferrule includes catch means (55; 55′; 55″) that are suitable for coming into engagement under an edge (414) of the ring.

9. A fastener device according to claim 9, in which the free intermediate gap (E) extends axially in continuous manner between the lip (53) and the catch means (55; 55′; 55″).

10. A fastener device according to claim 1, in which the bushing (41) of the ring forms an outwardly-directed shoulder (44) below the fastener means (42).

11. A fluid dispenser comprising: a fluid reservoir (1) provided with a neck (11); a dispenser member (2); and a fastener device according to claim 1.
